(19) United States
(12) Patent Application Publication
(10) Pub. No.: US 2010/0230279 A1
(43) Pub. Date: Sep. 16, 2010

(54) FLUORIDE ION SELECTIVE ELECTRODE

(76) Inventors: Zhisheng Sun, Hopkinton, MA (US); Steven J. West, Hull, MA (US); Xiaowen Wen, Lexington, MA (US); June Y. d'Heilly, Boston, MA (US)

Correspondence Address: CESARI AND MCKENNA, LLP, 88 BLACK FALCON AVENUE, BOSTON, MA, 02210, US

(21) Appl. No.: 12/789,645

(22) Filed: May 28, 2010

Related U.S. Application Data
(63) Continuation of application No. 11/361,124, filed on Feb. 24, 2006.

(51) Int. Cl. G01N 27/26; C09K 3/00

(52) U.S. Cl. 204/282; 252/182.11; 252/182.3

(57) ABSTRACT

A fluoride monitoring electrode comprises a single crystal of a lanthanum series fluoride doped with alkaline earth ions. The sample pre-treatment solution used in conjunction with the electrode includes a buffer that maintains a pH of 5 to 8 and a complexing agent that complexes iron and aluminum.

### CROSS-REFERENCE TO RELATED APPLICATIONS

The present application is a continuation of commonly assigned copending U.S. patent application Ser. No. 11/361,124, which was filed on Feb. 24, 2006, by Zhisheng Sun for an IMPROVED FLUORIDE ION SELECTIVE ELECTRODE and is hereby incorporated by reference.

### BACKGROUND OF THE INVENTION

1. Field of the Invention

This invention relates to the measurement of fluoride ions in an aqueous medium. More specifically, it relates to a fluoride ion-selective sensing electrode made of a single crystal of lanthanide fluoride doped with alkaline earth ions. The invention also relates to a sample pretreatment solution containing buffering and complexing agents sometimes referred to as TISAB (total ionic strength adjustment buffer) incorporated in the sample solution monitored by means of the electrode.

2. Background Information

For a number of years, ion-selective electrodes have been used to measure the concentration of fluoride ions without substantial interference from other ions present in the same solution. The voltage developed across an electrode exposed on one side to a sample solution of fluoride ions and, on the other side, a standard solution, is compared with the voltage developed by an electrode exposed to a reference solution, the voltage difference corresponding with the fluoride ion concentration in the sample solution. Since at least 1966, it has been known to use a fluoride ion-selective electrode employing the crystalline trifluoride of a metal of the lanthanide series (Frant and Ross, Science, vol. 154, 1553-1555 (1966); Frant, U.S. Pat. No. 3,431,182 (1969)). As set forth in the Frant patent, the sensing electrode is termed a “membrane,” consistent with its usage in potentiometric electrode technology. It embraces a non-porous sheet-like structure, generally regardless of flexibility or curvature, which provides a pair of limiting surfaces between which charge transfer is effected. The membranes disclosed by Frant and Ross are single crystals of pure lanthanum triflouride and also single crystals of lanthanum trifluoride doped with europium trifluoride. The latter combination exhibits low membrane resistance and is the most widely used single-crystal lanthanum membrane for fluoride-sensing electrodes.

The literature also includes descriptions of non-crystalline lanthanide membranes. For example, Kobos et al., U.S. Pat. No. 4,931,172 (1990), describe sintered membranes of the form (MF₂)₁₋ₓ(LnF₃)ₓ where M is an alkaline earth metal, such as calcium, strontium or barium, and Ln is a lanthanide series metal, such as lanthanum, cerium, praseodymium, europium, etc.

The electrodes also usually work with a sample pretreatment solution that maintains the pH at around pH 5.4, thereby limiting the effect of pH changes and OH⁻ interference, which occurs at high pH values, and HF which occurs at or below pH 5, reducing the fluoride ion activity in the solution. A widely used buffer has been acetate with pH range from 5 to 5.5. Although acetate is widely used as a sample pretreatment solution for fluoride measurement due to its excellent buffer nature for the pH range of 5 to 5.5, it increases the response time of the electrode, decreases the sensitivity, and deteriorates the detection limits of the analysis (Anfalt, T. and Jagner, D., Anal. Chim. Acta., 47, 483-494 (1969); Anfalt, T. and Jagner, D., Anal. Chim. Acta., 50, 23-30 (1970)). For this reason, the literature describes the use of a morpholinoethanesulfonic acid-based buffer that improves the detection limit of fluoride ion-selective electrodes in the pH range of 5 to 5.5. However, there is no mention of using similar biological organic acid so buffers beyond the pH range of 5 to 5.5 (Fouskaki M., Sotiropoulou S., Kochi M. and Chaniotakis N. A., Anal. Chim. Acta., 478, 77-84 (2003)).

### SUMMARY OF THE INVENTION

The present invention is a fluoride-sensing cell that includes a membrane electrode made with a single-crystal pellet of trifluoride lanthanide series rare earth metals such as lanthanum, cerium, praseodymium, neodymium, promethium, samarium, or europium, doped with alkaline earth metals ion such as strontium, barium and calcium, illustratively at a concentration in the range of 0.1 to 20 percent m/m. Specifically, the membrane compositions are characterized by the formula (MF₂)₁₋ₓ(LnF₃)ₓ where (MF₂)₁₋ₓ is the proportion of alkaline earth and (LnF₃)ₓ is the proportion of the lanthanide-series metal. The performance of a strontium-doped lanthanum trifluoride single crystal is superior to electrodes constructed of particles of the ingredients, whether by sintering or by incorporation into a polymeric matrix, for the analysis of fluoride by an ion-selective electrode. The performance of a strontium-doped lanthanum trifluoride single crystal is also superior to one doped with europium: it has a lower detection limit and a wider pH range. Compared to the single crystal of trifluoride lanthanide doped with europium, the detection limit can be extended 5 to 10-fold lower, to the 0.003 ppm fluoride range, and the pH range can be extended to pH 8 from pH 5.5 with 0.01 ppm fluoride detectable.

For fluoride measurement by fluoride ion-selective electrodes, many sample pretreatment solutions additionally employ a masking agent to preferentially complex any potentially interfering species, e.g. di- and trivalent cations, especially aluminum and iron, and thus remove them from the sample solution. Trans-1,2-diaminocyclohexane-N,N,N′,N′-tetraacetic acid (CDTA) has found wide usage (Nicholson, K. and Duff, E. J., Anal. Lett. 14(A12), 887-912 (1981)); and citric acid, disodium 1,2-dihydroxybenzene-3,5-disulphonate (Tiron), sodium ethylenediaminotetraacetate (EDTA) and, potassium tartrate also have been described in use as complexing agents (Nicholson, K., Duff, E. J., Anal. Lett., 14 (A12), 887-912 (1981); David E. Davey, Dennis E. Mulcahy, Trevor J. Muggleton and Gregory R. O'Connell, Anal. Lett, 25 (3), 607-624 (1992); Akio, Yuchi, Kazuhiro Ueda, Hiroko Wada, Genkichi Nakagawa, Anal. Chim. Acta., 186, 313-318 (1986). These complexing agents are used in the pH range of 5 to 5.5; however, the complexing ability may be increased by increasing the pH of sample pretreatment solution above pH 5.5.

Instead of using acetate buffers in the range of pH 5 to 5.5, this invention uses a sample pretreatment solution providing a pH range of 5 to 8. For example, one may use organic acids such as 3-(N-morpholino)propanesulfonic acid (MOPS), 3-(N-morpholino)-2-hydroxypropanesulfonic acid (MOPSO), N-(2-hydroxyethyl)piperazine-N′-(2-ethanesulfonic acid) (HEPES), 2-(N-morpholino)ethanesulfonic acid (MES), piperazine-N,N′-bis(2-ethanesulfonic acid) (PIPES), 3-[N,N-bis(2-hydroxyethyl)amino]-2-hydroxypropanesulfonic acid (DIPSO) and other biological buffers, also called Good's buffers (Good et al. Biochemistry, 5, 467-77(1966); Ferguson et al., Analytical Bio-chemistry 104, 300-310 (1980)). Compared to acetate buffers, these buffers show improved detection limits for fluoride measurement. Also in these buffer systems, complexing agents show stronger complexing properties, resulting in improved selectivity of fluoride measurement in presence of interference from aluminum and iron, for example. It should be understood that the invention is not limited to these buffers. Other organic or inorganic buffers may also be used. The invention also contemplates the use of a single compound, such as 5-sulfosalicylic acid as both a buffer and a complexing agent.

### BRIEF DESCRIPTION OF THE DRAWINGS

The invention description below refers to the accompanying drawings, of which:

FIG. 1 is a cross section of an electrode embodying the principles of the invention;

FIG. 2 is a schematic view of a cell incorporating the electrode of FIG. 1; and

FIGS. 3-8 are plots of the response of the electrode of the present invention, including comparisons with a prior electrode (Curve 1) and the prior art (Curve 2).

### DETAILED DESCRIPTION OF AN ILLUSTRATIVE EMBODIMENT

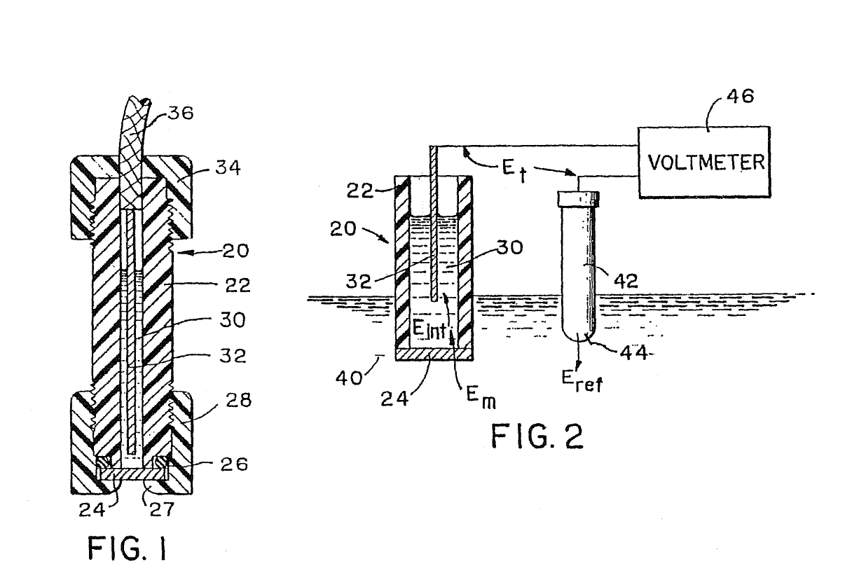

Referring now to the drawing, there is shown in FIG. 1 and FIG. 2 an electrode 20 embodying the principles of the present invention and comprising an elongated, hollow tubular container or stem 22 open at both ends. The stem typically is formed of a liquid-impervious, substantially rigid, electrically-insulating material, such as unplasticized polyvinylchloride, polytetrafluoroethylene, or the like, substantially chemically inert to salt solutions containing fluoride ions with which the stem might be placed in contact.

One end of stem 22 is capped or sealed with a barrier disc or membrane 24 formed of a substantially imporous, high-purity, crystalline fluoride. The membrane can be quite thick, for example, 0.25 inch although thinner structures are preferred. Membrane 24 can be sealed across the one end of the stem 22 with an appropriate sealing compound such as an epoxy or polyester resin. Alternatively, as shown, the membrane is mounted by an O-ring 26 disposed about the periphery of the opening in the stem, and held in pressed-fit against the O-ring by annular flange 27 of collar 28 threadedly mounted on the stem. When collar 28 is rotated in the proper direction, it advances axially, forcing membranes 24 in a tight fit against the O-ring, thus sealing the one end of stem 22. Both the O-ring and collar 28 are preferably made of plastic material such as polyvinylchloride.

Disposed internally of stem 22 and in electrical and physical contact with the inner surface of membrane 24 is a charge transfer means providing a fixed concentration of ions. This means is shown as a reference electrolyte 30, for example, an aqueous solution of KCl, saturated with AgCl, and 1 mmolar in fluoride from KF. Immersed in electrolyte 30 is internal reference electrode 32, for example the well-known Ag—AgCl element. This combination of electrolyte 30 and reference electrode 32 provides for electrical contact with the internal interface (i.e. the surface of the membrane contacting the reference electrolyte) at a substantially stable or fixed potential. The other, open, end of stem 22 is fitted with an annular cap 34 having an aperture in which is sealed the usual coaxial cable 36, the central conductor of which is connected to internal reference electrode 32 and the peripheral conductor of which is intended to provide electrostatic shielding. The outer surface of membrane 24 is exposed to the sample solution whose fluoride content is to be measured.

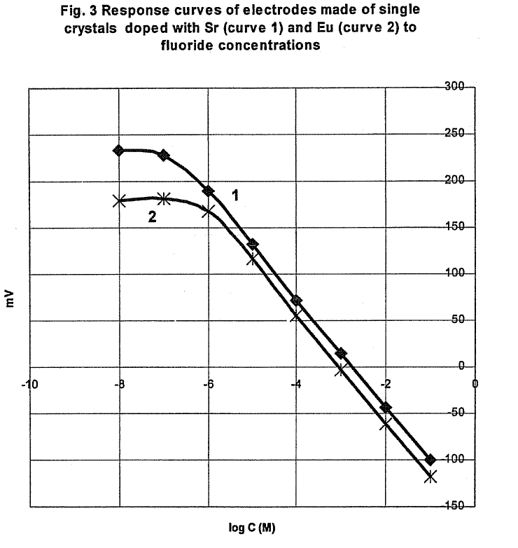

The present inventors have discovered that a membrane fashioned from a single-crystal pellet of a lanthanide series trifluoride, doped with strontium, provides an improved electrode response to fluoride ions, with a detection limit that can be extended to 10-fold lower, to the 0.003 ppm, than a single-crystal pellet of trifluoride lanthanide doped with europium. FIG. 3 compares the response curves of a single-crystal pellet of lanthanide trifluoride doped with strontium and a prior art single crystal doped with europium.

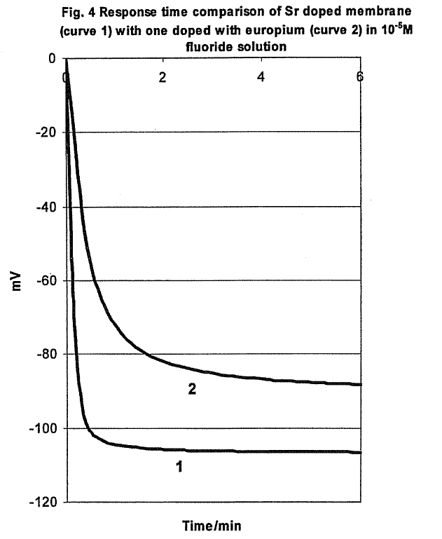

Response time is also an important criterion for electrode performance. Although the membrane comprising a single crystal of lanthanum trifluoride doped with europium has found wide usage for measurement of fluoride ions, the electrode response is slow, especially in solutions of less than 1 ppm fluoride, taking up to 5 minutes to stabilize. The present membrane has a much shorter response time. FIG. 4 shows a response time comparison of a strontium-doped electrode and one doped with europium.

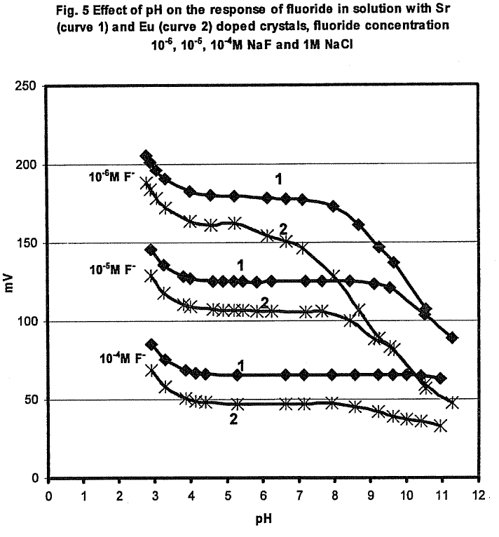

FIG. 5 shows the effect of pH on the response of fluoride electrodes in solutions with two different electrodes. The present electrode exhibits a wider useable pH range for response to fluorides. It extends the useable range up to pH 8, even in fluoride concentrations less then 1 ppm. In the solution of 10⁻⁶M fluoride ion (0.02 ppm), the electrode with the present art made with strontium-doped crystals showed no effect of pH value change from 5 to 8, while the electrode of the prior art made with Eu-doped crystals showed response deterioration with pH increase from 5 to 8. In the solution of 10⁻⁵ M fluoride ion (0.2 ppm), the electrode with present art showed no effect from a pH value change from 5 to 9.5, while the electrode with old art showed response deterioration with pH increase from pH 5.5 to pH 9.

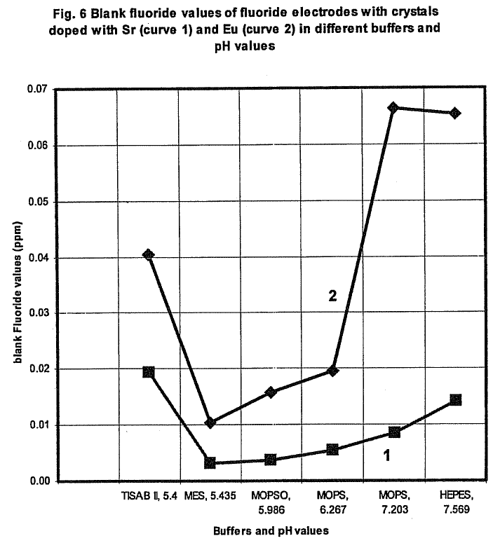

FIG. 6 shows the blank values of different buffers. The blank values, i.e., measurements in which the sample contains no fluoride ions and are indicative of the lower limit of detection of sample pre-treatment solutions for fluoride measurement. It can be seen that for the same electrode, buffers described above exhibit lower detection limits than acetate buffers. Also, electrodes made of 5% strontium doped crystals show blank fluoride values less than 0.01 ppm in MES pH 5.4, MOPSO pH 5.9, MOPS pH 6.3, or MOPS pH 7.2 buffers, while electrodes made of 0.5% Eu doped crystals show 0.01 ppm blank values only in pH 5.4 buffers.

With the pH range extended to pH 8, 5-sulfosalicylic acid (SSA), citric acid, tartaric acid, Tiron, EDTA and CDTA, for example, can be used as the complexing agents. It is well known that complexing agents tend to improve complexing power when pH values increase. (Anders Ringbom, Complexation in Analytical Chemistry, Interscience Publishers, 1963). Conditional constant of the complexing with metal ions is increased with the increasing of pH values in solution. As an example, Table 1 lists the conditional constants of complexing agents EDTA, CDTA and citrate with A1 ion under different pH values.

TABLE 1
Conditional constants of some complexing agents EDTA,
CDTA and citrate with Al ion at different pH values
(from Anders Ringbom, Complexation in Analytical Chemistry,
Interscience Publishers, 1963, p352)

| pH | EDTA | CDTA | Citrate |
|---|---|---|---|
| 2 | 1.8 | 0.2 | |
| 3 | 4.1 | 2.8 | 1.8 |
| 4 | 6.2 | 5.5 | 5.2 |
| 5 | 8.2 | 7.6 | 8.6 |
| 6 | 10.3 | 9.4 | 11.3 |
| 7 | 12.5 | 10.8 | 13.6 |
| 8 | 14.5 | 12.3 | 15.6 |
| 9 | 16.5 | 14.3 | 17.6 |

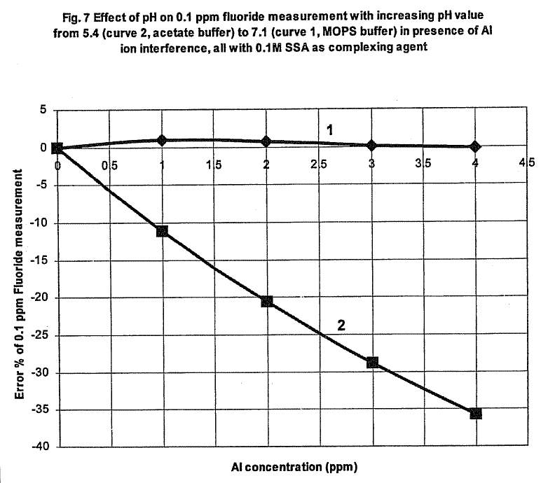

FIG. 7 shows 0.1 ppm fluoride measurement in the presence of A1 ion interference with 0.1M SSA as a complexing agent at pH 5.4 and pH 7.1. With increasing pH from 5.4 (curve 1, acetate buffer) to 7.1 (curve 2, MOPS buffer), curve 2 (at pH 7.1) showed much less A1 ion interference for fluoride measurement compared to curve 1 (at pH 5.4). The selectivity of the present invention is improved greatly compared to the prior art of acetate buffers with complexing agent trans-1,2-diaminocyclohexane-N,N,N′,N′-tetraacetic acid (CDTA).

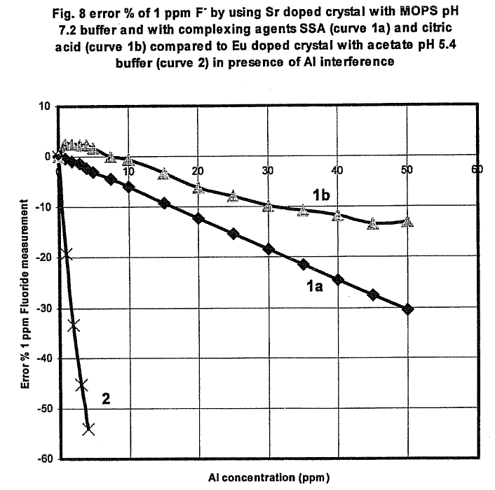

FIG. 8 shows a test error of 1 ppm fluoride in the presence of different concentrations of A1 interference. It can be seen that selectivity with A1 interference can be improved at least 10 fold compared to standard method (Method 4500F) based on the prior art. With the prior art, 2 ppm A1 can cause 10% measurement error for 1 ppm fluoride, while with the inventive buffers, 2 ppm A1 causes negligible error for 1 ppm fluoride measurement. If a 10% error is permissible, the present invention can tolerate 30 ppm A1 in the solution, while the prior art can tolerant only 2 ppm A1. Similar improvement has also been observed for other interference such as iron (III).

### Example 1

In example 1, the electrode was made of a single crystal of trifluoride lanthanum (LaF₃) doped with 5% m/m strontium (Sr). The single crystal was then cut into a disc, about 8 mm in diameter and 1.6 mm thick. The finish on all surfaces was ground by a 320-mesh diamond abrasive. The pellet was mounted over the end of a polystyrene tube and glued with an epoxy as permanent seal. The latter was filled with an aqueous solution with 1 molar fluoride in KCl as well as saturated with AgCl. An Ag—AgCl electrode was placed in the internal solution. The single crystal surface was polished to a mirror surface after epoxy was cured fully.

This electrode was tested in a configuration using an Ag—AgCl external reference electrode. A number of aqueous solutions of sodium fluoride at different concentrations were tested. The response in mV for different fluoride concentrations in sample solutions for the electrode and a prior art electrode are listed in Table 2.

TABLE 2
Fluoride Response of Single Crystal trifluoride lanthanum doped
with strontium vs. europium in 1:1 acetate buffer solutions

| Fluoride ion | Reading in mV, (LaF₃ | Reading in mV, (LaF₃ |
|---|---|---|
| concentration, | Single Crystal | Single Crystal |
| mol/L | Doped with Sr) | Doped with Eu) |
| 10⁻¹ | −100.1 | −118.1 |
| 10⁻² | −43.7 | −61.6 |
| 10⁻³ | 14.3 | −3.4 |
| 10⁻⁴ | 72.3 | 55.1 |
| 10⁻⁵ | 132.1 | 116.9 |
| 10⁻⁶ | 189.6 | 168 |
| 10⁻⁷ | 228.3 | 181.8 |

### Example 2

In example 2, the electrode of Example 1 was tested with a sample pre-treatment solution buffer, which has the following composition:

0.5 moles/liter MOPS where 0.25 moles/liters sodium form and 0.25 moles/liter acid form,

115 1.0 moles/liter sodium chloride

0.1 moles/liter 5-sulfosalicylic acid or citric acid or tartaric acid

This solution has pH about 7. 0.5 moles/liter MOPS also can be made with 0.5 moles/liter MOPS with acid form and then adjusted pH to 6.5 to 7.5 with a sodium hydroxide solution, or MOPS with sodium, and then adjusted pH to 6.5 to 7.5 with addition of HCl acid to the solution.

### Example 3

In example 3, the electrode was tested in a sample pre-treatment solution, which has the following composition: 0.2 moles/liter HEPES where 0.10 moles/liter sodium form and 0.10 moles/liter acid form;

1.0 moles/liter sodium chloride

0.1 moles/liter 5 sulfosalicylic acid or citric acid or tartaric acid

This solution has pH about 7.5. 0.2 moles/liter HEPES also can be made with 0.2 moles/liter HEPES with acid form and then adjusted pH to 7.0 to 8.0 with addition of NaOH to the solution. It also can be made with 0.2 miles/liter HEPES sodium form and then adjusted pH to 7.0 to 8.0 with addition of HCl into the solution.

### Example 4

In example 4, the electrode was tested in a sample pre-treatment solution, which had the following composition:

0.1 mole/liter MOPSO where 0.05 moles/liter sodium form and 0.05 mole/liter acid form;

1.0 moles/liter sodium chloride

0.1 moles/liter 5-sulfosalicylic acid or citric acid or tartaric acid

This solution had a pH about 6.7. 0.1 moles/liter MOPSO also can be made with 0.1 moles/liter MOPSO with acid form and then adjusted pH to 6.5 to 7.0 with addition of NaOH to the solution. It also can be made with 0.1 miles/liter MOPSO sodium form and then adjusted pH to 6.5 to 7.0 with addition of HCl into the solution.

### Example 5

In example 5, the electrode of example 1 tested in a sample pre-treatment solution, which had the following composition:

0.2 mole/liter MES where 0.1 moles/liter sodium form and 0.1 moles/liter acid form;

1.0 moles/liter sodium chloride

0.1 moles/liter 5-sulfosalicylic acid or citric acid or tartaric acid

This solution has a pH about 5.5. 0.2 moles/liter MES also can be made with 0.1 moles/liter MES with acid form and then adjusted pH to 5 to 6 with addition of NaOH to the solution. It also can be made with 0.2 miles/liter MES sodium form and then adjusted pH to 5 to 6.0 with addition of HCl into the solution.

### Example 6

In example 6, the electrode is tested in a sample pre-treatment solution, which has the following composition:

0.5 mole/liter MOPS where 0.25 moles/liter sodium form and 0.25 moles/liter acid form;

2.0 moles/liter sodium chloride

0.1 moles/liter 5-sulfosalicylic acid or citric acid or tartaric acid

This solution has a pH of about 7 with complexing agent 5-sulfosalicylic acid. Citric acid or tartaric acid, or other complexing agents also can be used as a complexing agent. This sample pre-treatment solution can be used with up to 40 ppm A1 and 200 ppm Fe (III).

What is claimed is:

1. A fluoride ion-selective electrode for monitoring the fluoride ion concentration in a sample solution, said electrode comprising a single-crystal membrane of a rare earth fluoride doped with strontium or barium ions.

2. The electrode of claim 1 in which the rare earth fluoride is lanthanum fluoride and the dopant is strontium ions.

3. The electrode of claim 1 in which the dopant concentration is in the range of 0.1 to 20 percent m/m.

4. A sample pre-treatment solution for use with a fluoride ion-selective electrode comprising a single crystal membrane of a rare earth fluoride doped with alkaline earth ions, the solution containing:
A. a buffering agent capable of maintaining a pH in the range of greater than 5.5 to 8; and
B. a complexing agent capable of complexing aluminum and iron.

5. The sample pre-treatment solution of claim 4 in which the complexing agent and the buffering agent are the same compound.

6. The sample pre-treatment solution of claim 4 in which the buffering agent and complexing agent are different compounds.

7. The sample pre-treatment solution of claim 4 in which the buffering agent is an acid compound selected from the group of MOPS, MOPSO, HEPES, MES, PIPES, BIS-TRIS and DIPSO.

8. The sample pre-treatment solution of claim 4 in which the complexing agent is from the group of 5-sulfosalicylic acid, citric acid, tartaric acid, CDTA, EDTA, and Tiron.

9. A fluoride ion-selective electrode for monitoring the fluoride ion concentration in a sample solution, said electrode comprising a single crystal membrane of a rare earth fluoride doped with strontium ions or barium ions, said electrode used with a sample pre-treatment solution containing a buffering agent capable of maintaining a pH in the range of 5-8 and a complexing agent capable of complexing aluminum and iron.

10. An electrode as in claim 9 in which the rare earth fluoride is lanthanum fluoride and the dopant is strontium ions.

11. The electrode as in claim 9 in which the dopant ion concentration is in the range of 0.1 to 20 percent m/m.

12. The sample pre-treatment solution as in claim 9 wherein the complexing agent and the buffering agent are the same compound.

13. The sample pre-treatment solution of claim 9 in which the complexing agent and buffering agent are different compounds.

14. A sample pre-treatment solution as in claim 9 in which the buffer solution is an compound selected from the group of MOPS, MOPSO, HEPES, MES, PIPES, BIS-TRIS and DIPSO.

15. A sample pre-treatment solution as in claim 9 wherein the complexing agent is selected from the group of 5-sulfosalicylic acid, citric acid, tartaric acid, CDTA, EDTA and Tiron.

16. The sample pre-treatment solution of claim 5 in which the complexing agent and the buffering agent are 5-sulfosalicylic acid.

17. The sample-pre-treatment solution of claim 4 in which the buffering agent is capable of maintaining a pH in the range of 6.5-8.

18. A sample pre-treatment solution for use with a fluoride ion-selective electrode comprising a single crystal membrane of a rare earth fluoride doped with alkaline earth ions, the solution containing:
A. a buffering agent capable of maintaining a pH in the range of 5-8, the buffering agent being an acid compound selected from the group of MOPS, MOPSO, HEPES, PIPES, BIS-TRIS and DIPSO; and
B. a complexing agent capable of complexing aluminum and iron.

19. A fluoride ion-selective electrode for monitoring the fluoride ion concentration in a sample solution, said electrode comprising a single crystal membrane of a rare earth fluoride doped with alkaline earth ions, said electrode used with a sample pre-treatment solution containing a buffering agent capable of maintaining a pH in the range of 6.5-8 and a complexing agent capable of complexing aluminum and iron.
